(19) United States
(12) Patent Application Publication
(10) Pub. No.: US 2024/0399287 A1
(43) Pub. Date: Dec. 5, 2024

(54) SOFT SENSING ALKANOLAMINE CONCENTRATION FOR INTELLIGENT CIRCULATION OPTIMIZATION

(71) Applicant: SAUDI ARABIAN OIL COMPANY, Dhahran (SA)

(72) Inventors: Hasan M. Alshafei, Saihat (SA); Abdulrahman M. Alharbi, Saihat (SA)

(73) Assignee: SAUDI ARABIAN OIL COMPANY, Dhahran (SA)

(21) Appl. No.: 18/325,778

(22) Filed: May 30, 2023

(51) Int. Cl. B01D 53/14; B01D 53/18; B01D 53/52; B01D 53/62; B01D 53/78

(52) U.S. Cl. CPC B01D 53/1412; B01D 53/1425; B01D 53/1462; B01D 53/1468; B01D 53/1475; B01D 53/18; B01D 53/526; B01D 53/62; B01D 53/78; B01D 2252/204; B01D 2257/304; B01D 2257/308; B01D 2257/504

(57) ABSTRACT

A method may include obtaining gas sweetening data for first gas sweetening cycle of a gas sweetening system. The method may further include determining, by a computer processor, an amine soft sensor prediction using a machine-learning model and the gas sweetening data. The method may further include transmitting, by the computer processor, the amine soft sensor prediction to the plant server. The method may further include determining, by a plant server computer processor, a target amine circulation flow rate using optimization logic equations and the amine soft sensor prediction. The method may further include transmitting, by the plant server computer processor, the target amine circulation flow rate to the control system of the gas sweetening unit based on the amine soft sensor prediction and optimization logic equations.

### BACKGROUND

Amine gas treating is a process that is widely used in refineries, petrochemical plants, natural gas processing plants, and other applications. Amine gas treating, also known as amine scrubbing, gas sweetening, and acid gas removal, is a process that uses an aqueous amine solution to remove hydrogen sulfide (H₂S), carbon dioxide (CO₂), and carbonyl sulfide (COS), and other acid gases, from hydrocarbon gas streams. Gas streams containing one or more of the acid gases may be referred to as “sour gas” whether it is from a natural or a fabricated source.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method that includes obtaining gas sweetening data for first gas sweetening cycle of a gas sweetening system. The gas sweetening system includes an amine flow rate manager and a control system coupled to a plant server, a plurality of gas sweetening units, and a plurality of sensors configured to determine one or more properties of the plurality of gas sweetening units. The plurality of gas sweetening units includes at least one cooler, an absorbing unit, and an amine regenerating unit. The absorbing unit is configured to remove acid gas by reaction with an amine. The amine regenerating unit is configured to remove acid gas from a rich amine. The method further includes determining, by a computer processor, an amine soft sensor prediction using a machine-learning model and the gas sweetening data. The method further includes transmitting, by the computer processor, the amine soft sensor prediction to the plant server. The method further includes determining, by a plant server computer processor, a target amine circulation flow rate using optimization logic equations and the amine soft sensor prediction. The method further includes transmitting, by the plant server computer processor, the target amine circulation flow rate to the control system of the gas sweetening unit based on the amine soft sensor prediction and optimization logic equations.

In general, in another aspect, embodiments disclosed herein relate to a gas sweetening system. The gas sweetening system includes a plant server, an amine flow rate manager, a plurality of gas sweetening units that include a cooler, an amine regenerating unit, and an absorbing unit, and a control system coupled to the plant server and the plurality of gas sweetening units. The plurality of gas sweetening units include a plurality of sensors configured to determine temperature, pressure, fluid composition, flow rate, or combinations thereof. The control system includes a computer processing unit. The control system performs a method that includes obtaining gas sweetening data for first time period of a gas sweetening system. The method further includes determining, by a computer processor, an amine soft sensor prediction using a machine-learning model and the gas sweetening data. The method further includes transmitting, by the computer processor, the amine soft sensor prediction to the plant server. The method further includes determining, by the computer processor, a target amine circulation flow rate using optimization logic equations and the amine soft sensor prediction. The method further includes transmitting, by the computer processor, the target amine circulation flow rate to the control unit of the gas sweetening unit.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an example gas sweetening system in accordance with one or more embodiments.

FIG. 2 shows an example control unit of a gas sweetening system in accordance with one or more embodiments.

FIG. 3 shows a gas sweetening network in accordance with one or more embodiments.

FIG. 4 illustrates a neural network in accordance with one or more embodiments.

FIG. 5 shows a computer system in accordance with one or more embodiments.

FIGS. 6A and 6B show flowcharts in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Natural gases carry acids, namely, carbon dioxide (CO₂), hydrogen sulfide (H₂S), carbonyl sulfide (COS), among others, which hinder the production and separation of hydrocarbons. Amine solutions are often selected as acid gas removal agents in a closed circulation loop commonly known as a “gas sweetening process.” Gas sweetening systems and processes utilize amine solutions to purify sour gases that include, but are not limited to, a natural sour gas, a sour gas derived from one or more hydroprocessing units (e.g., a hydrotreating unit or a hydrocracking unit), or both. Sour gas is treated with amine solutions that flow in a cycle for continuous removal of acid gas from the sour gas feed to produce a “sweetened” gas that includes hydrocarbons.

Traditionally, gas sweetening process control logic for amine circulation is a feedback controller of a control system coupled to the gas sweetening system. In such instances, the feedback controller varies an amine circulation flow rate to maintain a bottom tray temperature located proximate to an absorbing unit of a gas sweetening system. Following the treatment provided in the absorbing unit, the resultant amine, now rich with acid gas, is transported to the regenerating unit. The regenerating unit regenerates the amine in the amine solution via removal of the acid gas. The regenerated amine is then transported to the absorbing unit via one or more amine pumps such that the lean amine is recycled to the contactor to sweeten a sour gas feed. In such processes, the energy consumption in multiple units, including regeneration reboilers, amine pumping systems, and cooler fin-fan motors, is proportional to circulation rate of the gas sweetening process. The amine circulation flow rate of a traditional gas sweetening system is increased once a bottom tray temperature of an absorbing unit exceeds a setpoint.

A drawback for controlling the amine circulation flow rate is that the traditional control logic does not differentiate additional factors that lead toward high tray temperature. For instance, one additional factor is the lean amine feed temperature. In instances with low performance of a lean amine cooler, an amine circulation flow rate rate will increase the load for cooler; thus, causing higher lean amine temperature. In turn, a traditional gas sweetening system using traditional control features can lead to lower separation efficiencies, increased impurities (e.g., higher acid gas content) in sweetened gas, and higher energy costs.

In general, embodiments of the disclosure relate to systems and methods for optimizing amine circulation rate for gas sweetening systems and processes using machine-learning. Embodiments in accordance with the present disclosure generally relate to processes and systems for treating “sour gas streams,” understood to mean a stream of gas that has a “sour gas” component in it, such as acid gas including but not limited to H₂S, CO₂, COS, or combinations thereof. Systems and methods of such embodiments may address problems associated with energy consumption, amine circulation, acid gas slippage, sour gas slippage, and controlling one or more units of a gas sweetening system.

Generally, embodiments in accordance with the present disclosure involve the utilization of a machine-learning model to dynamically learn and predict optimal gas sweetening parameters in real-time based on practical constraints. Such parameters include, but are not limited to amine circulation rate, amine concentration, or both. For example, various states of a gas sweetening system may be predicted using various machine-learning models, such as artificial neural networks. Example states may include the amine concentration, composition of acid gas in a sour gas feed, concentration of an acid gas in the sour gas, amine concentration at various stages of the gas sweetening system, acid gas concentration at various stages of the gas sweetening system, and temperature of various gas sweetening units.

The term “lean” as in a “lean amine” or “lean amine solution” refers to the reaction capacity of the amines in the solution, that is, the amines in the amine solution are operable to react with acid gases. A “rich” stream as in “rich amine” or “rich amine solution,” on the other hand, means that a significant portion of the amines in the amine solution have reacted with an acid gas to form amine-acid gas products, such as acid sulphides, and therefore do not have the capacity to perform additional reactions. The reaction is reversible, so when the conditions are reversed, such as in a “regeneration unit,” the amine-acid gas products break down back into the amines in solution and dissolved acid gas. The acid gas bubbles out of the solution and the amine solution is once again “lean.” The term “acid gas loading” refers to a reaction between the acid gas and amine such that the acid gas is selectively removed from the sour gas feed.

In one aspect, embodiments of this disclosure relate to a gas sweetening system coupled to a control unit and an amine flow rate manager. For the purposes of the present disclosure, accompanying components that are conventionally used in amine gas sweetening systems, such as pumps and compressors, gas handling apparatuses, valves, sensors, electronic controllers, heat exchangers, and mixers, are not shown or discussed for the sake of simplicity, although in an actual operating system these and many more apparatuses and systems would be included. One of ordinary skill in the art appreciates that such components may be included in the embodiments disclosed.

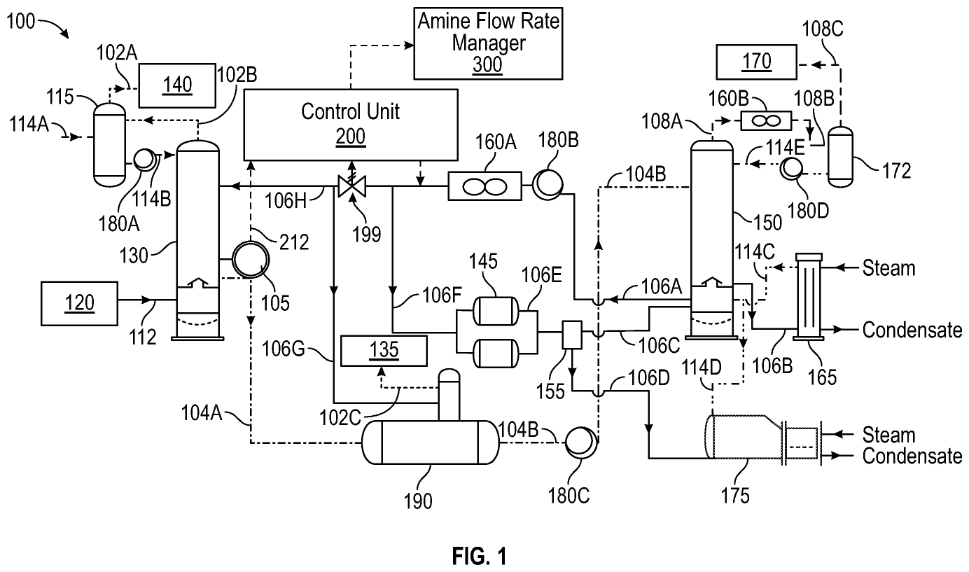

FIG. 1 shows a schematic of an exemplary gas sweetening system 100 in accordance with one or more embodiments. As shown in FIG. 1, the gas sweetening system may include a plurality of fluid pumps ((180A)-(180D)), a plurality of lean amine flow lines ((114A)-(114E)), a plurality of rich amine flow lines ((104A)-(104B)), a plurality of regenerated amine flow lines ((106A)-(106H)), acid gas outlet flow lines ((108A)-(108C)), sweet gas outlet flow lines ((102A)-(102C)), one or more regenerated amine coolers (e.g., (160A)), one or more acid gas coolers (e.g., (160B)), one or more particulate filters (145), one or more splitting joints (155), a water make up feed (not shown), or any combination thereof.

In some embodiments, gas sweetening system (100) includes a plurality of gas sweetening units that may be in electrical connection with a control unit (200). In some embodiments, control unit (200) is coupled via electrical connection to an amine flow rate manager (300). Control unit (200) may be coupled to an amine flow rate manager (300) via network connection. In some embodiments, control unit (200) is coupled to a plurality of sensors (not shown) coupled to one or more gas sweetening units of the gas sweetening system (100).

In some embodiments, the plurality of sensors includes sensors selected from temperature sensors, pressure sensors, flow rate sensors, liquid level sensors, or any combination thereof. In some embodiments, the plurality of sensors may measure/acquire one or more properties of the plurality of gas sweetening units such that the plurality of sensors acquires gas sweetening data. The plurality of sensors may include a water feed flow rate sensor, a lean amine inlet flow rate sensor, a lean amine inlet temperature sensor, a sour gas inlet flow rate sensor, a sour gas inlet temperature sensor, an overhead pressure transmitter coupled to absorbing unit (130), an overhead pressure sensor coupled to regenerating unit (150), a liquid level sensor coupled to regenerating unit (150), or any combination thereof.

For example, temperature sensor(s) (e.g., temperature sensor (105)) may be axially coupled to absorbing unit (130). In some embodiments, six temperature sensors are axially coupled to absorbing unit (130). In some embodiments, seven temperature sensors are axially coupled to absorbing unit (130). In some embodiments, eight temperature sensors are axially coupled to absorbing unit (130). In some embodiments, nine temperature sensors are axially coupled to absorbing unit (130). In some embodiments, ten temperature sensors are axially coupled to absorbing unit (130). In some embodiments, eleven temperature sensors are axially coupled to absorbing unit (130).

The absorbing unit (130) may be in fluid connection with a sweet gas coalescing unit (115). The sweet gas coalescing unit (115) may be configured to receive a sweetened gas from absorbing unit (130) and an amount of an amine solution from a fresh lean amine flow line (114A) such that the sweetened gas is allowed to coalesce in sweet gas coalescing unit (115). The amine received in sweet gas coalescing unit 115 may be pumped with fluid pump (180A) via lean amine flow line (114B) to absorbing unit (130) for acid gas loading. The absorbing unit (130) receives the first lean amine solution.

The amine of one or more embodiments is not particularly limited and may comprise an amine that is suitable for the removal of a desired amount of acid gas from the sour gas feed to produce a sweetened gas. The amines may include, but are not limited to, one or more selected from the group comprising primary amines, secondary amines, tertiary amines, alkanolamines, and combinations thereof. In some embodiments, the amine solution may include, but is not limited to, monoethanolamine (MEA), diethanolamine (DEA), diglycolamine (DGA), diisopropanolamine (DIPA), N-methyldiethanolamine (MDEA), triethanolamine (TEA), piperazine (PZ), 2-amino-2-methyl-1-propanol (AMP), and combinations thereof.

In some embodiments, the amine circulating through the gas sweetening system is an aqueous amine solution. A lean amine solution of one or more embodiments may have an amine concentration in the range of about 15 to 40 percent by weight (wt. %) of the lean amine solution. For example, the lean amine solution of one or more embodiments may have an amine concentration in a range having a lower limit of any of 15, 20, 25, 30, and 35 wt. %, and an upper limit of any of 20, 25, 30, 35, and 40 wt. %, where any lower limit may be used in combination with any mathematically-compatible upper limit. The amine concentration of one or more embodiments may be dependent on the type of the amine used. For example, the lean amine solution may have an amine concentration of about 40 wt. %. In another example, the amine solution may have an amine concentration of about 18 wt. %. The lean amine solution may have a residual amount of an acid gas, such as hydrogen sulfide, to mitigate equipment and piping corrosion. In some embodiments, the loading of hydrogen sulfide to amine in the lean amine solution is equal to or greater than about 0.010 mol/mol amine, such as in having a hydrogen sulfide loading a range of from about 0.010 to about 0.015 mol/mol amine.

In some embodiments, absorbing unit (130) receives a sour gas feed from a sour gas source (120) via sour gas inlet (112), a fresh lean amine (or a fresh lean amine solution) from a fresh lean amine flow line (114A), and a regenerated lean amine (e.g., via regenerated lean amine flow line (106H)), such that the absorbing unit receives a recycled amine to completes an “amine recycle” or “amine loop.” Absorbing unit (130) promotes acid gas loading of the lean amine to form a rich amine and a sweetened gas by promoting a reaction as described above. As mentioned above, the sweetened gas may be passed to a sweet gas coalescing unit (115) via sweet gas flow line (102B). The sweetened gas may be collected in collection unit (140).

In some embodiments, a rich amine solution contains rich amine in a range from 35 to 40 mol % and water in a range from 55 to 60 mol %. In some embodiments, the rich amine, or rich amine solution, has other components that were merely dissolved in the absorbing unit (130) that are recoverable. In some embodiments, the rich amine solution has a free acid gas concentration that is significant. For example, the free acid gas concentration is in a range of from about 1 to about 4 mol % of the rich amine solution may comprise “free” acid gas (that is, acid gas that is unreacted with amines; merely dissolved in water). There may also be smaller yet recoverable amounts of hydrogen, light hydrocarbons, and medium hydrocarbons in the rich amine solution, in rich amine flow lines, or in the absorbing unit (130).

Referring back to FIG. 1, a rich amine may be transferred to a flash drum (190) via rich amine outlet flow line (104B). Flash drum (190) may separate residual sweetened gas and lean amine such that residual sweetened gas is collected in collection unit (135) via sweet gas line (102C). Lean amine may be collected and recycled from flash drum (190) to absorbing unit (130) via lean amine outlet flow line (106G).

The flash drum (190) is operated at a reduced pressure compared to absorbing unit (130). This causes the introduced rich amine, or rich amine solution, to drop from a greater pressure condition to the reduced pressure condition, creating the “flash” that results in gases escaping the rich amine solution through a turbulent boil. In some configurations, internal structures of the flash drum are configured to spread the introduced rich amine thinly so that the amount of distance a coalescing gas in the liquid has to travel to the surface of the liquid and into the gas phase is reduced, facilitating degassing of the liquid. Atomizing nozzles, packing, distributor plates, and “smash” or “slam” plates (that is, a sacrificial barrier that the fluid is introduced onto to spray the liquid thinly in all directions) are known and appreciated.

Flash drum (190) forms two products from the rich amine solution: flashed sour gas and flash drum rich amine. In some embodiments, flashed sour gas is passed back toward the absorbing unit via a flashed sour gas flow line (not shown). The flashed sour gas may include hydrogen gas (i.e., H₂). In one or more embodiments, the flashed sour gas may be comprised of hydrogen gas in a concentration of about 10 mol % or less. In some embodiments, the flashed sour gas is substantially free of hydrogen gas.

The flashed sour gas may have a C₁₋₄ concentration that is a significant portion of the gas. In one or more embodiments, the flashed sour gas may be comprised of C₁₋₄ in a concentration having a range of from about 1 mol % to about 99 mol %. In one or more embodiments, the flashed sour gas may be comprised of C₁₋₄ concentration in a range having a lower limit of any one of 1, 5, 10, 20, 30, 40, 50, 60, 70 and 75 mol %, and an upper limit of any of 5, 10, 20, 30, 40, 50, 70, 90 95, and 99 mol %, where any lower limit may be used in combination with any mathematically-compatible upper limit. The flashed sour gas may have a C₅₊ concentration that is an incidental portion of the gas.

The flashed sour gas may have an acid gas concentration that is a substantial portion of the gas. In one or more embodiments, the flashed sour gas may be comprised of hydrogen sulfide in a concertation having a range of from about 10 mol % to about 20 mol %. In one or more embodiments, the flashed sour gas may have an acid gas concentration in a range having a lower limit of any one of 10, 11, 12, 13, 15, 17, 18, or 19 mol %, and an upper limit of any of 11, 12, 13, 15, 17, 18, 19 or 20 mol %, where any lower limit may be used in combination with any mathematically-compatible upper limit.

The flash drum rich amine solution from the bottom of the flash drum has several components. Like the rich amine from which it originated, flash drum rich amine mostly contains rich amine (about 35 to about 40 mol %) and water (from about 55 to about 60 mol %). Flash drum rich amine may be passed via rich amine outlet flow line (104B) with pump 180C from flash drum (190) to regenerating unit (150).

Regenerating unit (150) may be configured to regenerate a lean amine and an acid gas from a rich amine via a reverse reaction as described above. An acid gas may be passed from regenerating unit (150) to an acid gas outlet line (108C) via acid gas outlet lines (108A) and (108B). The acid gas may be passed through a cooler 160B to generate a cooled acid gas that may be passed to an acid gas coalescing unit (172). In some embodiments, an acid gas may coalesce in acid gas coalescing unit (172). The acid gas may be passed from acid gas coalescing unit (172) to an acid gas collection unit (170) via acid gas line (108C). Residual lean amine collected in acid gas coalescing unit (172) may be passed back to regenerating unit (150) via flow line (114E) with pump (180D).

Regenerating unit (150) may include one or more lean amine outlet flow lines. Outlet flow line (106A) may pass regenerated lean amine to cooler (160A) with pump 180B. A portion of the regenerated and cooled lean amine may be passed to from cooler (160A) to absorbing unit (130) via regenerated lean amine flow line (106H). In some embodiments, a portion of the regenerated and cooled lean amine is passed to flash drum (190) to undergo acid gas loading for residual acid gas trapped by rich amine transferred from absorbing unit (130). In some embodiments, a portion of regenerated and cooled lean amine may be passed via lean amine flow line (106F) to one or more particulate filters (145) to separate solids from the lean amine. The lean amine passed through one or more particulate filters (145) may then be passed to a splitting joint (155) via lean amine flow line (106E). The splitting joint (155) may split the lean amine feed to lean amine flow line (106C) in fluid connection with regenerating unit (150), such that the filtered lean amine is passed to regenerating unit (150). The splitting joint (155) may split the lean amine feed to filtered lean amine flow line (106D) in fluid connection with reboiler (175). In some embodiments, reboiler (175) generates steam from a rich amine solution. Generating steam enhances the driving force for the removal of acid gases from the rich amine to regenerate a lean amine by lowering the partial pressure. Generated steam may be passed to regenerating unit (150) via flow line (114D).

Regenerating unit (150) may include a regenerated lean amine outlet flow line 106B, which passes regenerated lean amine to amine reclaimer (165). Amine reclaimer (165) may be used to treat thermally stable salts in a lean amine solution, such as with the addition of a more basic compound than the amine. Generated lean amine vapor may be passed from amine reclaimer (165) to regenerating unit (150) via vapor flow line (114C) and further recycled to absorbing unit (130).

As mentioned above, gas sweetening system (100) includes a control unit (200). Control unit (200) may be configured to receive one or more transmitted signals (represented by dashed arrow (212)) from the plurality of sensors of the gas sweetening system. Control unit (200) may be a distributed control system. With respect to distributed control systems, a distributed control system may be a computer system for managing various processes at a facility using multiple control loops. As such, a distributed control system may include various autonomous controllers (such as remote terminal units (RTUs)) positioned at different locations throughout the facility to manage operations and monitor processes. Likewise, a distributed control system may include no single centralized computer for managing control loops and other operations. With respect to an RTU, an RTU may include hardware and/or software, such as a microprocessor, that connects sensors and/or actuators using network connections to perform various processes in the automation system.

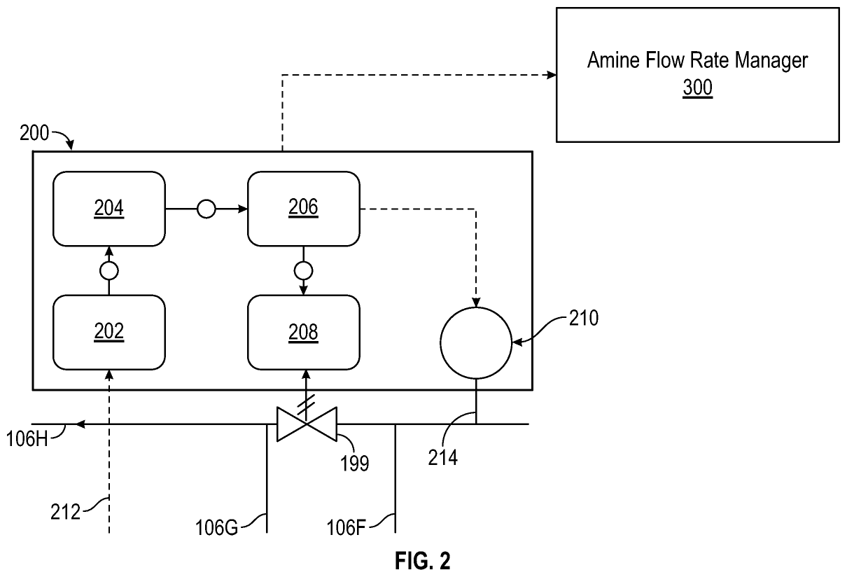

As shown in FIG. 2, a control unit (200) may be configured to transmit the collected and/or transformed data as gas sweetening data to an amine flow rate manager (300) of a gas sweetening system network. In some embodiments, control unit (200) may be configured to transmit data relating to the gas sweetening system to the amine flow rate manager (300) via a plant server (not shown). Control unit (200) may include at least two analyzers configured to transform one or more signals transmitted to the analyzers from the gas sweetening system to concentration and/or composition. The analyzers may transform the transmitted signals to an acid gas content of the sweet gas, a residual gas content, a flow-temperature differential value, or combinations thereof. Control unit (200) may include three or more analyzers. Control unit (200) may include four or more analyzers. Control unit (200) may include at least four analyzers.

In some embodiments, control unit (200) includes a thermal conductivity analyzer (202), a residual gas analyzer (204), an additional gas analyzer (206) a fluid temperature differential analyzer (208), or any combination thereof. In some embodiments, control unit (200) is in electrical connection with a sensor (199). Sensor (199) may be configured to detect and transmit one or more signals related to amine temperature and flow rate downstream of cooler (160A). Control unit (200) may be configured to modify a lean amine flow rate via flow controller (210), which may be in electrical connection with the flow lines, such as via electrical connection (214).

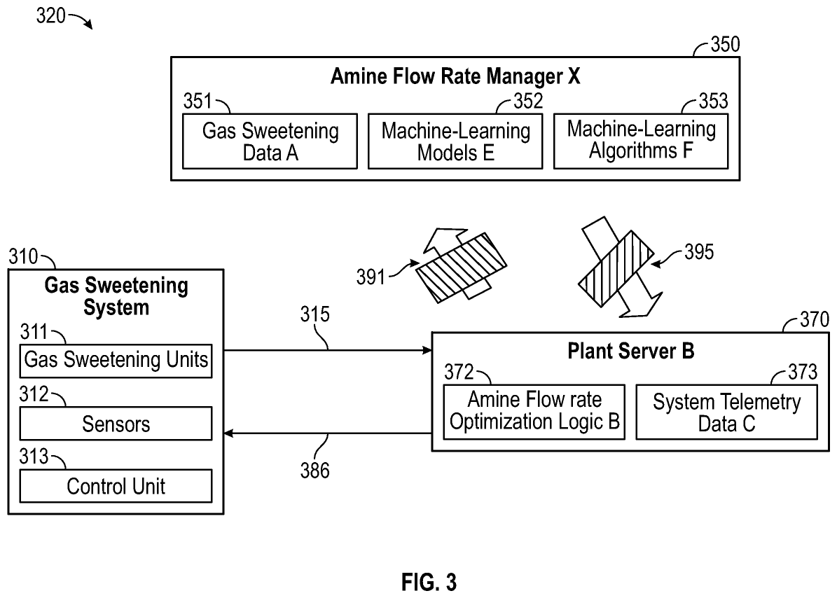

Turning to FIG. 3, FIG. 3 shows a schematic diagram in accordance with one or more embodiments. As shown in FIG. 3, a gas sweetening network (e.g., gas sweetening network A (320)) may include at least one gas sweetening system (e.g., gas sweetening system (310)), a plant server (e.g., plant server B (370)), various network elements (not shown), and/or an amine flow rate manager (e.g., amine flow rate manager X (350)). In one or more embodiments, amine flow rate manager X (350) may be a gas sweetening plant server. In some embodiments, gas sweetening data (e.g., gas sweetening data X (391)) are collected over the gas sweetening network. Likewise, the gas sweetening network may also determine amine soft sensor prediction data (e.g., amine soft sensor prediction B (395)) regarding an amine concentration of the gas sweetening units throughout the gas sweetening network.

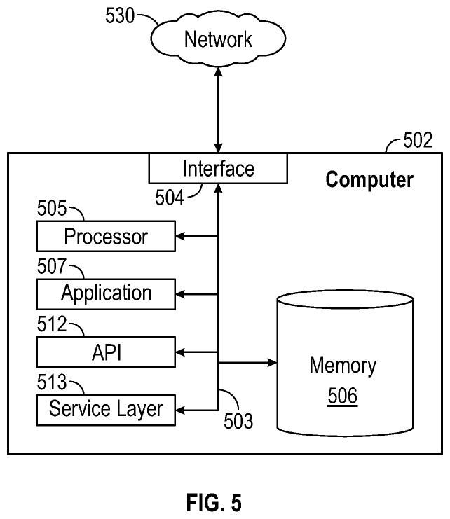

Furthermore, the gas sweetening system (e.g., gas sweetening system (310)) may include a plurality of gas sweetening units (e.g., gas sweetening units (311)), a plurality of sensors (e.g., sensors (312)), and a control unit (e.g., control unit (313)), which may be as described above. A control unit (e.g., control unit (313)) in a gas sweetening system may control various operations of the gas sweetening system, such as amine flow rate, acid gas loading operations, various temperatures throughout the gas sweetening process, sweetened gas composition monitoring, acid gas composition monitoring, amine composition monitoring, sour gas composition monitoring, gas sweetening system maintenance operations, assessment and development operations. In some embodiments, the control unit includes a computer system that is the same as or similar to that of computer system (502) described below in FIG. 5 and the accompanying description.

A control unit (e.g., control unit (313)) may transmit system gas sweetening data (e.g., gas sweetening data (315)) to a plant server (e.g., plant server B (370)). A plant server (e.g., plant server B (370)) may include amine flow rate optimization logic algorithms (e.g., amine flow rate optimization logic B (372)) and system telemetry data (e.g., system telemetry data C (373)). System telemetry data may include one or more physical properties (e.g., amine density, amine flash point, amine heat capacity, amine molar mass, etc.) of the amine used in the gas sweetening system. Plant server B (370) may transmit the gas sweetening data received from gas sweetening system (310) to an amine flow rate manager (e.g., amine flow rate manager X (350)). Plant server B (370) may transmit an optimized amine flow rate (e.g., optimized amine flow rate data (386) to a gas sweetening system (e.g., gas sweetening system (310)).

An amine flow rate manager (e.g., amine flow rate manager X (350)) includes hardware and/or software for collecting data in real-time from various gas sweetening systems, gas sweetening system plants, sensors coupled to hardware equipment and pipe components, user devices, and other systems in the gas sweetening network. For example, an amine flow rate manager may be one or more plant servers with functionality for obtaining data throughout the gas sweetening system and the plant server, such as gas sweetening data (e.g., gas sweetening data X (391)). For example, gas sweetening data may include sensor data for various units and flow lines of the gas sweetening system (e.g., pressure data, temperature measurements, and amine circulation flow rates) and data received from the at least two analyzers. Gas sweetening data may also include gas chemical composition data, such as condensate-gas ratio (CGR) data, and water sampling data. Likewise, gas sweetening data may also include material and design specification for various pipe components that form gas sweetening flow lines, such as pipe component geometry and pipe component compositions. The amine flow rate manager may also collect various gas production parameters regarding acidic gas plant operations, gas well operations, and remote header information regarding the gathering system coupled to the gas sweetening system.

In some embodiments, an amine flow rate manager includes functionality for determining and/or modifying one or more gas sweetening operations based on amine concentration data, gas sweetening unit data obtained from one or more sensors, one or more physical properties of the amine compound used for sweetening a sour gas, a predicted amine concentration, an optimized amine circulation flow rate, and/or a target amine circulation flow rate. A gas sweetening operation may include modifying an initial amine circulation flow rate within the gas sweetening system based on the inability of the initial amine circulation flow rate to satisfy a predetermined criterion (e.g., to improve acid gas loading in the amine, thereby reducing the concentration of acid gas in a sweetened gas).

In some embodiments, an amine soft sensor prediction is generated by the amine flow rate manager X (350) upon obtaining an instruction (e.g., a network message transmitted between a control unit of a gas sweetening system and the amine flow rate manager) using input data (e.g., gas sweetening data X (351)) for a particular time period. In one or more embodiments, the gas sweetening data includes data transmitted from a plurality of sensors along with data transmitted from four analyzers. In such embodiments, the gas sweetening data is used as inputs to an artificial neural network. For a particular time interval, an artificial neural network may predict an amine soft sensor prediction, which may include an amine concentration at a designated location in the gas sweetening process for the particular time interval.

In some embodiments, the amine flow rate manager includes functionality for transmitting an amine soft sensor prediction (e.g., amine soft sensor prediction B (395)) to a plant server to optimize an amine circulation flow rate as described above. For example, the amine flow rate manager X (350) may transmit a network message over a machine-to-machine protocol to a plant server B (370) including an amine flow rate optimization logic algorithm (e.g., amine flow rate optimization logic B (372)). An amine soft sensor prediction may be transmitted periodically, based on a user input, or automatically based on changes in gas sweetening data.

In some embodiments, an optimization control logic algorithm is used to determine an optimal amine circulation flow rate for the gas sweetening system. The control logic algorithm may be built through physics informed selection include an optimization logic built from Equations (1) through (6) provided below.

$${F}^{n} = max \{ F 1 , F 2 \} \qquad Equation ( 1 )$$

$$F 1 = 60 [ \frac{s}{min} ] * {MM}_{m} [ \frac{kg}{kgmol} ] * \frac{1}{{ρ}_{m}} [ \frac{gal}{kg} ] * UA [ \frac{kW}{K} ] * \frac{1}{{C}_{{P}_{m}}} [ \frac{kgmol * K}{kJ} ] \qquad Equation ( 2 )$$

$$F 2 = AG [ \frac{mol}{mol} ] * SF [ \frac{lbmol}{hr} ] * \frac{1}{C} [ \frac{kg}{kg} ] * \frac{1}{RL} [ \frac{mol}{mol} ] * \frac{1}{60} [ \frac{hr}{min} ] * \frac{1}{{ρ}_{m}} [ \frac{gal}{lb} ] * {MM}_{m} [ \frac{lb}{lbmol} ] \qquad Equation ( 3 )$$

$$HD = {F}^{n - 1} [ \frac{gal}{min} ] * {ρ}_{m} [ \frac{kg}{gal} ] * \frac{1}{{MM}_{m}} [ \frac{kgmol}{kg} ] * \frac{1}{60} [ \frac{min}{s} ] * {C}_{{P}_{m}} [ \frac{kJ}{kgmol * K} ] * ( {T}_{LA , i}^{n - 1} - {T}_{LA , o}^{n - 1} ) [ K ] \qquad Equation ( 4 )$$

$$LMTD = ( ( {T}_{LA , o}^{n - 1} - ( {T}_{LA , o}^{n - 1} - MT ) ) - ( {T}_{LA , i}^{n - 1} - {T}_{amb}^{n - 1} ) ) * \frac{1}{ln ( \frac{{T}_{LA , 0}^{n - 1} - ( {T}_{LA , o}^{n - 1} - MT )}{{T}_{LA , i}^{n - 1} - {T}_{amb}^{n - 1}} )} \qquad Equation ( 5 )$$

$$UA = HD / LMTD \qquad Equation ( 6 )$$

where the parameters for heat capacity (C_{P}_{ₘ}), density (ρₘ), and molar mass (MMₘ) are correlated based upon the alkanolamine concentration (C). The remaining inputs reflected in the Equations above include the molar concentration of acid gas in sour feed gas (AG), sour feed gas (SF), target rich loading (RL), lean amine temperature upstream the lean cooler (T_{LA,i}), lean amine temperature downstream the lean cooler (T_{LA,o}), minimum temperature driving force (MT), and overall heat transfer coefficient for lean cooler (UA). In the above equations, MT and RL are constants, which can be determined by a gas sweetening system operator. For example, the values for MT and RL may be determined as 5° C. and 0.38, respectively.

An amine flow rate manager (e.g., amine flow rate manager X (350)) may include hardware and/or software with functionality for generating and/or updating one or more machine-learning models (e.g., machine-learning models E (352)) to determine predicted amine circulation flow data. Examples of machine-learning models may include random forest models and artificial neural networks, such as convolutional neural networks, deep neural networks, and recurrent neural networks. Machine-learning models may also include support vector machines, decision trees, inductive learning models, deductive learning models, supervised learning models, unsupervised learning models, reinforcement learning models, etc. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network. In some embodiments, two or more different types of machine-learning models are integrated into a single machine-learning architecture, e.g., a machine-learning model may include K-nearest neighbor (k-NN) models and neural networks. In some embodiments, an amine flow rate manager may generate augmented data or synthetic data to produce a large amount of interpreted data for training a particular model.

In some embodiments, various types of machine-learning algorithms (e.g., machine-learning algorithm F (353)) may be used to train the model, such as an artificial neural network. In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. A machine-learning model may be updated using the training data and based on a loss function and a mismatch between the training data and acquired gas sweetening data regarding one or more gas sweetening operations for one or more predetermined time intervals. An updated machine-learning model may include a plurality of parameters that are adjusted based on the mismatch. Thus, a machine-learning model may be trained iteratively using epochs until the model achieves a predetermined criterion, such as predetermined level of prediction accuracy or training over a specific number of machine-learning epochs or iterations. Thus, better training of a model may lead to better predictions by a trained model.

In some embodiments, various types of machine-learning algorithms (e.g., machine-learning algorithm F (353)) may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

With respect to artificial neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine-learning, a neural network may determine which data inputs should receive greater priority in determining one or more specified outputs of the neural network. Likewise, these weighted data inputs may be summed such that this sum is communicated through a neuron's activation function to other hidden layers within the neural network. As such, the activation function may determine whether and to what extent an output of a neuron progresses to other neurons where the output may be weighted again for use as an input to the next hidden layer.

Keeping with artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

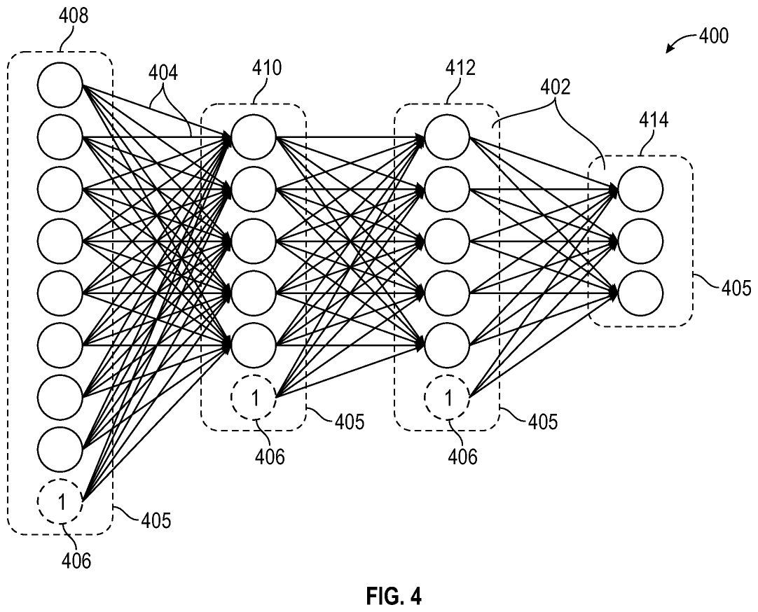

FIG. 4 shows a neural network, a common ML architecture for prediction/inference. At a high level, a neural network (400) may be graphically depicted as comprising nodes (402), shown here as circles, and edges (404), shown here as directed lines connecting the circles. The nodes (402) may be grouped to form layers, such as the four layers (408, 410, 412, 414) of nodes (402) shown in FIG. 4. The nodes (402) are grouped into columns for visualization of their organization. However, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be fully or sparsely connected. A neural network (400) will have at least two layers, with the first layer (408) considered as the “input layer” and the last layer (414) as the “output layer.” Any intermediate layer, such as layers (410) and (412) is usually described as a “hidden layer”. A neural network (400) may have zero or more hidden layers, e.g., hidden layers (410) and (412). However, a neural network (400) with at least one hidden layer (410, 412) may be described as a “deep” neural network forming the basis of a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The numerical value of an edge, or even the edge (404) itself, is often referred to as a “weight” or a “parameter”. While training a neural network (400), numerical values are assigned to each edge (404). Additionally, every node (402) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 1 )$$

where i is an index that spans the set of “incoming” nodes (402) and edges (404) and f is a user-defined function. Incoming nodes (402) are those that, when viewed as a graph (as in FIG. 4), have directed arrows that point to the node (402) where the numerical value is computed. Functional forms of ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed in the art. Each node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), and are depicted in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training, the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Recall that a given data set will be composed of inputs and associated target(s), where the target(s) represent the “ground truth”, or the otherwise desired output. The neural network (400) output is compared to the associated input data target(s). The comparison of the neural network (400) output to the target(s) is typically performed by a so-called “loss function”; although other names for this comparison function such as “error function” and “cost function” are commonly employed. Many types of loss functions are available, such as the mean-squared-error function. However, the general characteristic of a loss function is that it provides a numerical evaluation of the similarity between the neural network (400) output and the associated target(s). The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target(s) over the data set. Thus, the loss function is used to guide changes made to the edge (404) values, typically through a process called “backpropagation.”

The loss function will usually not be reduced to zero during training. And, once trained, it is not necessary or required that the neural network (400) exactly reproduce the output elements in the training data set when operating upon the corresponding input elements. Indeed, a neural network (400) that exactly reproduces the output for its corresponding input may be perceived to be “fitting the noise.” In other words, it is often the case that there is noise in the training data, and a neural network (400) that is able to reproduce every detail in the output is reproducing noise rather than true signal. The price to pay for using such a “perfect” neural network (400) is that it will be limited to fitting only the training data and not able to generalize to produce a realistic output for a new and different input that has never been seen by it before. An analog of this problem occurs when fitting a polynomial to data points. The higher the degree of the polynomial, the closer the resulting curve will be to fitting all the points (a high enough polynomial is guaranteed to fit all the points). However, higher degree polynomials will tend to diverge quickly away from the fit data point values—hence, a high degree polynomial will not exhibit generalizability.

Assuming a trained neural network (400) in this invention only approximately reproduces outputs for corresponding inputs, one may perform the following operation: a first neural network will be trained with estimated physical parameters as the input and rock characteristics as the output. Next, a second neural network will be trained on the same training data set in the opposite direction. The second neural network will take the rock characteristics as input and estimated physical parameters as outputs.

Turning to recurrent neural networks, a recurrent neural network (RNN) may perform a particular task repeatedly for multiple data elements in an input sequence (e.g., a sequence of temperature values or flow rate values), with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, an amine flow rate manager uses one or more ensemble learning methods to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

Furthermore, different types of machine-learning models may be trained, such as convolutional neural networks, U-Net models, deep neural networks, recurrent neural networks, inductive learning models, deductive learning models, supervised learning models, unsupervised learning models, reinforcement learning models, etc. In some embodiments, two or more different types of machine-learning models are integrated into a single machine-learning architecture, e.g., a machine-learning model may include different types of neural networks. In some embodiments, a control system generates augmented or synthetic data to produce a large amount of interpreted data for training a particular model.

Embodiments may be implemented on a computer system. FIG. 5 is a block diagram of a computer system (502) used to provide computational functionalities associated with described algorithms, methods, functions, processes, flows, and procedures as described in the instant disclosure, according to an implementation. The illustrated computer (502) is intended to encompass any computing device such as a high performance computing (HPC) device, server, desktop computer, laptop/notebook computer, wireless data port, smart phone, personal data assistant (PDA), tablet computing device, one or more computer processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. The illustrated computer (502) is communicably coupled with a network (530). In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502)) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (502). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or other suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504 includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer processor (505). Although illustrated as a single processor (505) in FIG. 5, two or more computer processors may be used according to particular needs, desires, or particular implementations of the computer (502). Generally, the computer processor (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), each computer (502) communicating over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

In some embodiments, the computer (502) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

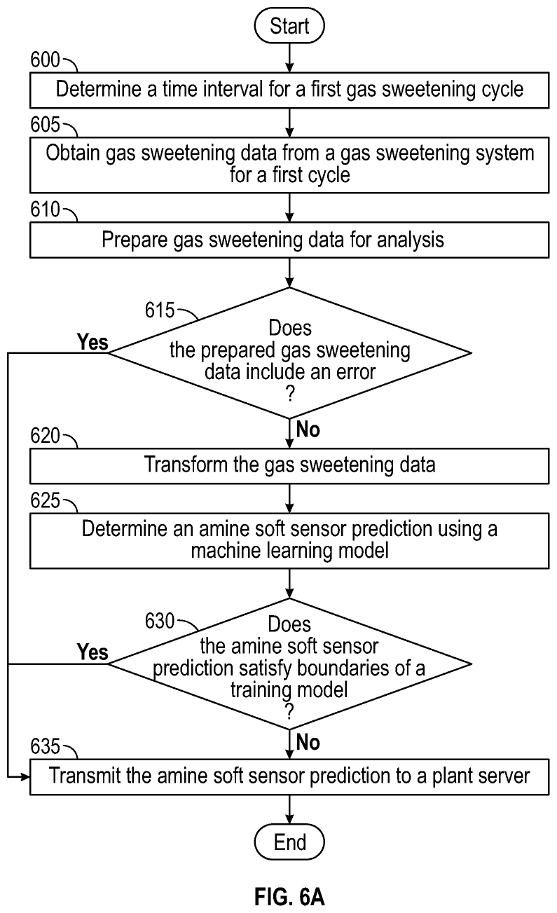

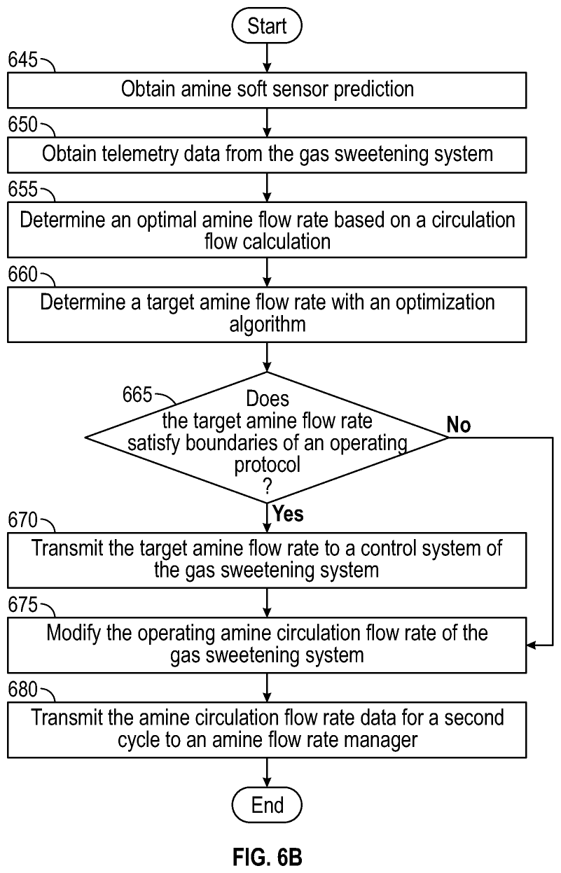

In another aspect, one or more embodiments relate to a method for optimizing an amine circulation flow rate of a gas sweetening system and a gas sweetening system network as described above. FIGS. 6A and 6B show flowcharts in accordance with one or more embodiments. Specifically, FIG. 6A describes a general method for generating an amine soft sensor prediction using machine-learning, and FIG. 6B describes a general method for optimizing an amine circulation flow rate in a gas sweetening system. One or more blocks in FIGS. 6A and 6B may be performed by one or more components (e.g., amine flow rate manager X (350), a plant server B (370), or both) as described in FIG. 3. While the various blocks in FIGS. 6A and 6B are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, a time interval is determined for first gas sweetening cycle in accordance with one or more embodiments. In some embodiments, a time interval includes a particular time step and a specific time horizon that is achieved using multiple time steps. Thus, a gas sweetening system may perform actions based on one or more amine soft sensor prediction at each time step until the time horizon is reached.

In some embodiments, a gas sweetening system automatically selects a particular time period for performing one or gas sweetening system operations. Likewise, an amine flow rate manager may receive a selection of a particular time intervals from a user. Moreover, time intervals may correspond to an hour, a 24-hour period, a week, a month, a year, or another predetermined time period for controlling electric power generation in an electric power distribution network. In some embodiments, gas sweetening network is managed in real-time, where the time interval is a periodic interval for updating electric power distribution in the network.

In Block 605, gas sweetening data is acquired for gas sweetening system in accordance with one or more embodiments. Gas sweetening data may include data as described above. Gas sweetening data may describe various constraints sweetening a sour gas, regenerating a lean amine, and/or the capabilities of various gas sweetening units. As such, gas sweetening data may identify the concentration of a lean amine introduced into an absorbing unit of a gas sweetening system. In some embodiments, gas sweetening data is collected by various sensors and/or control unit analyzers in a gas sweetening system.

In some embodiments, the process includes obtaining sour gas data for operating at least a portion of the plurality of gas sweetening units. The sour gas data may include a sour gas flow rate, an acid gas concentration in the sour gas, a sour gas feed composition, a temperature of a sour gas feed, or any combination thereof. The sour gas flow rate, the acid gas concentration in the sour gas, the sour gas feed composition, the temperature of a sour gas feed, or any combination thereof is used to update the amine soft sensor prediction

In Block 610, the gas sweetening data may be prepared for analysis in accordance with one or more embodiments. For example, preparation of the gas sweetening data for analysis may include normalization of the data. In some embodiments, normalizing the data is performed during a data cleaning stage. The data cleaning stage may be a stage in which the gas sweetening data is normalized in a range from 0 to 1 and fed to an amine flow rate manager. In some embodiments, normalizing the gas sweetening data includes using imputation if missing values occur. As one of ordinary skill may appreciate, the term “imputation” refers to the replacement of missing data with substitute values.

In Block 615, a determination is made if the prepared gas sweetening data includes an error in accordance with one or more embodiments. Where the prepared gas sweetening data includes an error, the process may proceed to Block 635 in which the prepared gas sweetening data may be transmitted to a plant server. Where the prepared gas sweetening data does not include an error, the process may proceed to Block 620 to transform the prepared gas sweetening data.

In Block 620, the prepared gas sweetening data may be transformed such that the prepared gas sweetening data is standardized. For example, standardization may be used to transform the prepared gas sweetening data. In some embodiments, standardization may be used to transform the prepared gas sweetening data after removing outlier data points. The standardized gas sweetening data may be provided as an average value of each data parameter with standard deviation.

In Block 625, an amine soft sensor prediction is determined for a predetermined time interval and a gas sweetening system based on acquired gas sweetening data, standardized gas sweetening data, normalized gas sweetening data, or combinations thereof and one or more machine-learning models in accordance with one or more embodiments. For example, an amine flow rate manager may determine an amine soft sensor prediction for the selected time interval from Block 600 in order to determine various states of the gas sweetening system. Where the predetermined time interval is a full cycle of a gas sweetening process, where a cycle includes forming a rich amine in an absorbing unit and recycling a lean amine in a regenerating unit and transporting the lean amine back to the absorbing unit, the amine soft sensor prediction may describe an lean amine concentration.

In Block 630, a determination is made if the amine soft sensor prediction satisfies the boundaries of a training model in accordance with one or more embodiments. Where the amine soft sensor prediction satisfies the boundaries of a training model, the process may proceed to block 635 in which the amine soft sensor prediction may be transmitted to a plant server. Where the amine soft sensor prediction does not satisfy the boundaries of the training model, the process may proceed to block 635 in which the amine soft sensor prediction may be transmitted to a plant server.

In Block 645 of FIG. 6B, an amine soft sensor prediction is obtained in accordance with one or more embodiments. The amine soft sensor prediction may be as described above. In Block 650, telemetry data may be obtained from a plant server and/or a gas sweetening system. Telemetry data may be as described above.

In Block 655, an optimal amine circulation flow rate may be determined in accordance with one or more embodiments. The circulation flow rate calculation may be determined from Equation (1), which is further defined by Equations (2) through (6). In some embodiments, the optimal amine circulation flow rate is calculated to meet the maximum value of rich amine loading criteria. The rich amine loading criteria may depend upon the type of amine used in the gas sweetening system, the target residual gas content in the sweetened gas, or both. The target residual acid gas content in the sweetened gas may be affected by a temperature of the lean amine.

In Block 660, a target amine circulation flow rate may be determined with an optimization logic algorithm in accordance with one or more embodiments. The optimization logic algorithm may include one or more of Equations (1) through (6) as described above.

In Block 665, a determination is made if the target amine circulation flow rate satisfies the boundaries of a gas sweetening system operating protocol in accordance with one or more embodiments. Where the target amine circulation flow rate satisfies a gas sweetening system operating protocol, the process may proceed to Block 670 in which the target amine circulation flow rate may be transmitted to a control unit of the gas sweetening system in accordance with one or more embodiments. The operating amine circulation flow rate may be modified to match the target amine circulation flow rate in Block 675. Where the target amine circulation flow rate does not satisfy the boundaries of a gas sweetening system operating protocol, the process may proceed to Block 675 in which the operating amine circulation flow rate of the gas sweetening system may be modified in accordance with one or more embodiments. In such embodiments, the operating amine circulation flow rates are determined to be in a range with an upper flow rate limit and a lower flow rate limit. The target amine flow rate may be restricted such that the target amine flow rate does not exceed the upper flow rate limit or decrease below the lower flow rate limit.

In Block 680, amine circulation flow rate data for a second cycle may be transmitted to an amine flow rate manager. As described above, amine circulation flow rate data for a second cycle may be transmitted to an amine flow rate manager via a plant server.

One or more embodiments of the present disclosure may have at least one of the following advantages. A gas sweetening system including a gas sweetening network in accordance with one or more embodiments may optimize energy consumption and avoiding acid gas breakthrough or slippage with sweet gas product. Energy consumption reduction may be estimated based upon reducing required heating duty to in one or more gas sweetening units, such as amine regeneration units including amine regenerating units, amine reboiler, power consumption for coolers, one or more pumps, or any combination thereof.

The singular forms “a,” “an,” and “the” include plural referents, unless the context clearly dictates otherwise. As used here and in the appended claims, the words “comprise,” “has,” and “include” and all grammatical variations thereof are each intended to have an open, non-limiting meaning that does not exclude additional elements or steps. When the words “approximately” or “about” is used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

The term “mostly” means greater than 50.00% of the overall composition by the stated unit of measure (mass/volume/mole). The term “substantial” means greater than 10.00% but less than or equal to 50.00% (that is, not a majority) of the overall composition by the stated unit of measure (mass/volume/mole). The term “significant” means greater than 1.00% but less than or equal to 10.00% (that is, not substantial) of the overall composition by the stated unit of measure (mass/volume/mole). The term “detectable” means equal to or greater than 0.01% but less than or equal to 1.00% (that is, not significant) of the overall composition by the stated unit of measure (mass/volume/mole). The term “incidental” means less than 0.01% of the overall compo sition by the stated unit of measure (mass/volume/mole). However, “incidental” does not exclude the material from the composition; rather, the term indicates that, if determined to be present using industry-available analytical equipment, its presence is de minimus for the purposes of this application.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining gas sweetening data for first gas sweetening cycle of a gas sweetening system,
wherein the gas sweetening system comprises an amine flow rate manager and a control system coupled to a plant server, a plurality of gas sweetening units, and a plurality of sensors configured to determine one or more properties of the plurality of gas sweetening units,
wherein the plurality of gas sweetening units comprise at least one cooler, a absorbing unit, and an amine regenerating unit,
wherein the absorbing unit is configured to remove acid gas by reaction with an amine, and
wherein the amine regenerating unit is configured to remove acid gas from a rich amine;
determining, by a computer processor, an amine soft sensor prediction using a machine-learning model and the gas sweetening data;
transmitting, by the computer processor, the amine soft sensor prediction to the plant server;
determining, by a plant server computer processor, a target amine circulation flow rate using optimization logic equations and the amine soft sensor prediction; and
transmitting, by the plant server computer processor, the target amine circulation flow rate to the control system of the gas sweetening unit based on the amine soft sensor prediction and optimization logic equations.

2. The method of claim 1,
wherein the machine-learning model is an artificial neural network, a deep neural network, a recurrent neural network, or combinations thereof.

3. The method of claim 1, further comprising:
preparing, by the computer processor, the gas sweetening data for analysis; and
transforming, by the computer processor, the prepared gas sweetening data, wherein transforming the gas sweetening data comprises normalizing, by the computer processor, the gas sweetening data.

4. The method of claim 1, further comprising:
determining, by the computer processor, a first action for the amine flow rate manager if the amine soft sensor prediction satisfies boundaries of a training model.

5. The method of claim 1, prior to the target amine circulation flow rate determination, further comprising:
obtaining telemetry data from the gas sweetening system; and
determining an optimal amine flow rate to satisfy a process parameter based on a circulation flow calculation.

6. The method of claim 1, further comprising:
modifying an operating amine circulation flow rate of the gas sweetening system based on the target amine circulation flow rate.

7. The method of claim 1, further comprising:
transmitting, by the plant server computer processor, a second amine circulation flow rate data for a second time period to the amine flow rate manager.

8. The method of claim 1, further comprising:
obtaining the gas sweetening data from the gas sweetening system via the plurality of sensors and at least two analyzers, wherein the gas sweetening data comprises a sweet gas composition, a sour gas feed composition, a sour gas feed flow rate, an amine inlet flow rate, an amine inlet composition, a rich amine loading value, temperature of one or more gas sweetening units, pressure of one or more gas sweetening units, or combinations thereof.

9. The method of claim 8, further comprising:
transmitting one or more signals from the plurality of sensors to one or more analyzers of the gas sweetening system, wherein the one or more analyzers determine a sweet gas composition, a sour gas feed composition, a sour gas feed flow rate, an amine inlet flow rate, an amine inlet composition, a rich amine loading value, temperature of one or more gas sweetening units, pressure of one or more gas sweetening units, or combinations thereof; and
transmitting, by the computer processor, an acid gas content of the sweet gas, a residual gas content of a rich amine, a residual acid gas content of a lean amine, an amine flow-temperature differential value, or combinations thereof to the amine flow rate manager.

10. The method of claim 5, further comprising:
obtaining sour gas data for operating at least a portion of the plurality of gas sweetening units,
wherein the sour gas data comprises a sour gas flow rate, an acid gas concentration in the sour gas, a sour gas feed composition, a temperature of a sour gas feed, or any combination thereof, and
wherein the sour gas flow rate, the acid gas concentration in the sour gas, the sour gas feed composition, the temperature of a sour gas feed, or any combination thereof is used to update the amine soft sensor prediction.

11. The method of claim 1,
wherein the plurality of gas sweetening units further comprises a reboiler, a reclaimer, a flash drum, one or more pumps, a flash drum, one or more filters, or any combination thereof.

12. The method of claim 1,
wherein the gas sweetening data comprises circulation flow data acquired from a plurality of flow rate sensors coupled to the plurality of gas sweetening units, and
wherein the amine soft sensor prediction is determined using the circulation flow data acquired from the plurality of flow rate sensors.

13. The method of claim 1,
wherein the gas sweetening data comprises temperature data that are acquired using a plurality of temperature sensors coupled to the plurality of gas sweetening units, and
wherein the amine soft sensor prediction is determined using the temperature data.

14. The method of claim 1,
wherein the gas sweetening data comprises temperature data for the plurality of gas sweetening units, flow rate data for the plurality of gas sweetening units, and pressure data for the plurality of gas sweetening units.

15. The method of claim 1, further comprising:
obtaining training data regarding one or more amine concentrations; and
updating, using the training data, the machine-learning model based on a loss function and a mismatch between the training data and gas sweetening data regarding one or more gas sweetening operations for one or more predetermined time intervals, and
wherein the updated machine-learning model comprises a plurality of parameters that are adjusted based on the mismatch.

16. A gas sweetening system, comprising:
a plant server;
an amine flow rate manager;
a plurality of gas sweetening units comprising a cooler, an amine regenerating unit, and an absorbing unit, wherein the absorbing unit is configured to remove acid gas from a sour gas feed by reaction with an amine, and wherein the amine regenerating unit is configured to remove acid gas from a rich amine; and
a control system coupled to the plant server and the plurality of gas sweetening units, wherein the plurality of gas sweetening units comprises a plurality of sensors configured to determine temperature, pressure, fluid composition, flow rate, or combinations thereof, and wherein the control system comprises a computer processor, wherein the control system is configured to perform a method comprising:
obtaining gas sweetening data for first time period of a gas sweetening system,
determining, by a computer processor, an amine soft sensor prediction using a machine-learning model and the gas sweetening data;
transmitting, by the computer processor, the amine soft sensor prediction to the plant server;
determining, by the computer processor, a target amine circulation flow rate using optimization logic equations and the amine soft sensor prediction; and
transmitting, by the computer processor, the target amine circulation flow rate to the control unit of the gas sweetening unit.

17. The system of claim 16, the method, prior to determining the target amine circulation flow rate, further comprising:
obtaining telemetry data from the gas sweetening system; and
determining an optimal amine circulation flow rate to satisfy a process parameter based on a circulation flow calculation.

18. The system of claim 16, the method further comprising:
obtaining the gas sweetening data from the gas sweetening system from the plurality of sensors, wherein the gas sweetening data comprises a sweet gas composition, a sour gas feed composition, a sour gas feed flow rate, an amine inlet flow rate, an amine inlet composition, a rich amine loading value, temperature of one or more gas sweetening units, pressure of one or more gas sweetening units, or combinations thereof.

19. The method of claim 18, further comprising:
transmitting one or more signals from the plurality of sensors to one or more analyzers of the gas sweetening system, wherein the one or more analyzers determine a sweet gas composition, a sour gas feed composition, a sour gas feed flow rate, an amine inlet flow rate, an amine inlet composition, a rich amine loading value, temperature of one or more gas sweetening units, pressure of one or more gas sweetening units, or combinations thereof; and
transmitting, by the computer processor, an acid gas content of the sweet gas, a residual gas content of a rich amine, a residual gas content of a lean amine, a flow-temperature differential value, or combinations thereof to the amine flow rate manager.

20. The system of claim 16, wherein the machine-learning model is an artificial neural network, a deep neural network, a recurrent neural network, or combinations thereof.
